(19) United States
(12) Patent Application Publication
(10) Pub. No.: US 2019/0089111 A1
(43) Pub. Date: Mar. 21, 2019

(54) AMPLIFICATION WAVEGUIDE DEVICES AND BEAM STEERING APPARATUSES

(71) Applicant: Samsung Electronics Co., Ltd., Suwon-si (KR)

(72) Inventors: Eunkyung LEE, Seoul (KR); Byounglyong Choi, Seoul (KR); Eunseog Cho, Yongin-si (KR)

(73) Assignee: Samsung Electronics Co., Ltd., Suwon-si (KR)

(21) Appl. No.: 16/134,366

(22) Filed: Sep. 18, 2018

(30) Foreign Application Priority Data
Sep. 21, 2017 (KR) 10-2017-0121872

(51) Int. Cl. H01S 3/063; G02B 6/12; H01S 3/06; H01S 3/16; H01S 3/00

(52) U.S. Cl. CPC H01S 3/0637; G02B 6/12; H01S 3/0623; G02B 2006/12147; H01S 3/0071; G02B 2006/12061; G02B 2006/12107; H01S 3/1608

(57) ABSTRACT

Amplification waveguide devices and beam steering apparatuses including the same may include a first core layer through which light is directed, an active layer that amplifies light incident thereof from the first core layer to generate amplified light, and a second core layer that directs amplified light that is incident on the second core layer from the active layer therethrough.

### CROSS-REFERENCE TO RELATED APPLICATION

This application claims priority to and the benefit of, under 35 U.S.C. § 119, Korean Patent Application No. 10-2017-0121872, filed on Sep. 21, 2017, in the Korean Intellectual Property Office, the disclosure of which is incorporated herein in its entirety by reference.

### BACKGROUND

### 1. Field

The present disclosure relates to amplification waveguide devices configured to progress light after amplification and beam steering apparatuses including the same.

### 2. Description of the Related Art

In order to steer a laser beam to a desired location, generally, a method of interfering with a bundle-type laser beam emitted from a plurality of unit cells or a plurality of waveguides by using a method of mechanically rotating a light source and an optical phased array (OPA) method is used. The method of mechanically rotating a light source uses a motor or a micro-electro-mechanical system (MEMS), and thus, a volume of the device may be increased, and in some example embodiments, cost may be increased. In the OPA method, a laser beam may be steered by electrically or thermally controlling unit cells or waveguides. Since the OPA method includes a plurality of waveguides, a volume of the device is increased. In modulating a phase by using the OPA method, there may be errors, and thus, the laser beam may have low light efficiency.

In a semiconductor-based OPA device, light amplified by a light-coupling may move through a waveguide by arranging a semiconductor amplification element on the waveguide. However, if the intensity of amplified light is high, light may not be coupled to the waveguide due to the nonlinear optical effect.

### SUMMARY

Provided are amplification waveguide devices configured to emit light of high power.

Provided are beam steering apparatuses configured to emit light of high power.

Additional aspects will be set forth in part in the description which follows and, in part, will be apparent from the description, or may be learned by practice of example embodiments.

According to some example embodiments, an amplification waveguide device may comprise a first waveguide, a light amplifier, and a second waveguide on a same layer as the light amplifier. The first waveguide may comprise a first core layer. The first core layer may be configured to direct light through the first waveguide. The light amplifier may comprise an active layer. The active layer may be configured to amplify light that is incident on the active layer from the first waveguide to generate amplified light. The second waveguide may comprise a second core layer. The second core layer may be configured to direct amplified light that is incident on the second core layer from the light amplifier through the second waveguide.

The second core layer may be associated with a nonlinear coefficient that is less than a nonlinear coefficient of the active layer.

The second core layer may comprise a material associated with a nonlinear coefficient that is equal to or less than 50.

The second core layer may comprise a silicon nitride material that is associated with a composition ratio of nitrogen and a composition ratio of silicon, and the composition ratio of nitrogen may be greater than the composition ratio of silicon.

An incident end of the second core layer may be inclined with an angle with respect to an optical-axis of the second core layer, the angle being greater than 55 degrees.

The active layer may directly contact the second core layer.

At least a portion of the second core layer may overlap the active layer with an optical-axis of the second core layer as a reference line.

The amplification waveguide device may further comprise a non-reflective coating layer between the active layer and the second core layer.

The non-reflective coating layer may comprise a plurality of material layers having refractive indexes different from each other.

The non-reflective coating layer may comprise a material having a refractive index between a refractive index of the active layer and a refractive index of the second core layer.

The first waveguide may be on a same layer as the light amplifier.

The first core layer and the second core layer may comprise a same material.

The first core layer may directly contact the active layer.

The first core layer may have a step difference with the active layer, such that an optical-axis of the first core layer is offset from an optical-axis of the active layer.

The first core layer may comprise silicon.

The active layer may be doped with ions.

The ions may comprise erbium ions.

According to some example embodiments, a beam steering apparatus may comprise a beam steering assembly, a first waveguide, a light amplifier, and a second waveguide on a same layer as the light amplifier. The beam steering assembly may be configured to change an emission direction of emitted light. The first waveguide may comprise a first core layer. The first core layer may be configured to direct emitted light that is incident on the first core layer from the beam steering assembly through the first waveguide. The light amplifier may comprise an active layer. The active layer may be configured to amplify light that is incident on the active layer from the first waveguide to generate amplified light. The second waveguide may comprise a second core layer. The second core layer may be configured to direct amplified light that is incident on the second core layer from the active layer through the second waveguide.

The beam steering apparatus may further comprise a coupler configured to couple light emitted from the beam steering assembly to the first waveguide.

The coupler may comprise a collimating lens, an optical fiber, a grating, a sub-combination thereof, or a combination thereof.

According to some example embodiments, an amplification waveguide device may comprise a light amplifier and a waveguide. The light amplifier may comprise an active layer. The active layer may be configured to amplify light that is incident on the active layer to generate amplified light. The waveguide may comprise a core layer. The core layer may be configured to direct amplified light that is incident on the core layer from the light amplifier through the waveguide.

The amplification waveguide device may further comprise a first waveguide comprising a first core layer. The first core layer may be configured to direct light through the first waveguide. The active layer may be configured to amplify light that is incident on the active layer from the first waveguide to generate amplified light. The waveguide may be a second waveguide and the core layer may be a second core layer. The active layer and the core layer may be are comprised in a unitary piece of material and the active layer may be at least partially defined by doped ions.

### BRIEF DESCRIPTION OF THE DRAWINGS

These and/or other aspects will become apparent and more readily appreciated from the following description of example embodiments, taken in conjunction with the accompanying drawings in which:

FIG. 1 is a schematic diagram of a beam steering apparatus according to some example embodiments;

FIG. 2 is a cross-sectional view taken along line II-II′ of FIG. 1 as an example of an amplification waveguide device according to some example embodiments;

FIG. 3 shows a Table showing Kerr coefficients and nonlinear coefficients of materials according to some example embodiments;

FIG. 4 is a cross-sectional view of an amplification waveguide device according to some example embodiments;

FIG. 5 is a diagram showing a connection relationship between an active layer and a second core layer according to some example embodiments;

FIG. 6 is a graph showing reflectivity according to an angle of an incident end of a second core layer according to some example embodiments;

FIG. 7 is a diagram showing a connection relationship between an active layer and a second core layer according to some example embodiments;

FIG. 8 is a graph showing measurement results of reflectivity when a non-reflective coating layer is arranged according to some example embodiments;

FIG. 9 is a cross-sectional view of an amplification waveguide device according to some example embodiments;

FIG. 10 is a schematic diagram of a beam steering apparatus including a collimating lens according to some example embodiments;

FIG. 11 is a schematic diagram of a beam steering apparatus including an optical fiber according to some example embodiments;

FIG. 12 is a schematic diagram of a beam steering apparatus including a grating according to some example embodiments;

FIG. 13 is a schematic diagram of a system including a beam steering apparatus according to some example embodiments; and

FIG. 14 is a schematic diagram of a beam steering apparatus according to some example embodiments.

### DETAILED DESCRIPTION

Amplification waveguide devices according to some example embodiments and beam steering apparatuses including the amplification waveguide device will now be described in detail with reference to the accompanying drawings. In the accompanying drawings, like reference numerals refer to like elements throughout, and sizes of constituent elements may be exaggerated for clarity of explanation and convenience of explanation. It will be understood that, although the terms “first”, “second”, “third”, etc., may be used herein to describe various elements, these elements should not be limited by these terms. These terms are only used to distinguish one element from another.

As used herein, the singular forms are intended to include the plural forms as well, unless the context clearly indicates otherwise. It should be understood that, when a part “comprises” or “includes” an element in the specification, unless otherwise defined, other elements are not excluded from the part and the part may further include other elements. When a particular (or, alternatively, predetermined) material layer is referred to as being on another layer, the material layer may directly contact a substrate or another layer, or a third layer may be therebetween. In some example embodiments, in the embodiments below, materials included in each of layers are examples, and thus, materials different from the materials may be used.

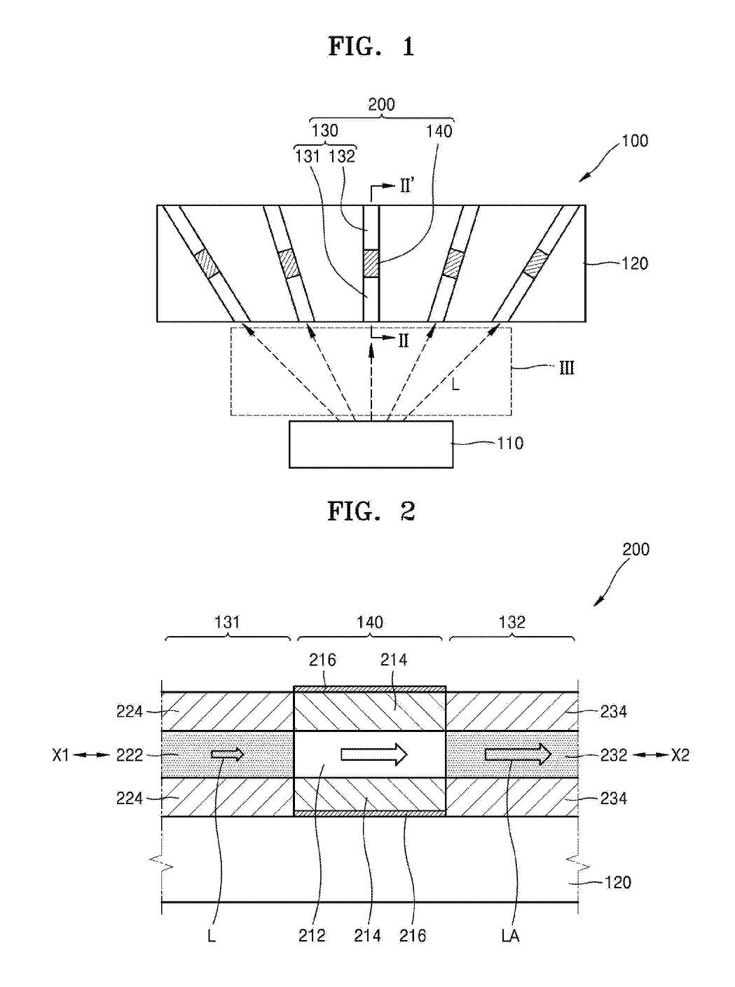

FIG. 1 is a schematic diagram of a beam steering apparatus 100 according to some example embodiments. FIG. 2 is a cross-sectional view taken along line II-II′ of FIG. 1 as an example of an amplification waveguide device 200 according to some example embodiments.

The beam steering apparatus 100 may include a beam steering unit 110 (“beam steering assembly”), a plurality of waveguides 130 through which light incident from the beam steering unit 110 may progress (“propagate,” “pass,” “be directed,” or the like), and light amplifiers 140 that may amplify light passing (“progressing,” “propagating,” “being directed,” or the like) through the waveguides 130. The waveguides 130 and the light amplifiers 140 may be arranged on a substrate 120. The substrate 120 may include a transparent glass material with SiO2 as a main component. However, the substrate 120 is not limited thereto, and may, for example, include a transparent plastic material.

The beam steering unit 110 may be configured to emit light L. The beam steering unit 110 may be configured to change an emission direction of the emitted light L. The beam steering unit 110 may have a laser scanning structure and may be configured to emit light L based on using a micro-electro-mechanical system (MEMS) method, having an optical phased array structure, having a meta-radar structure, some sub-combination thereof, or a combination thereof. The beam steering unit 110 may control a progress direction of emitted light L to enter the waveguides 130.

The waveguides 130 and the light amplifiers 140 may at least partially comprise the amplification waveguide device 200. The waveguides 130 may be arranged (“configured”) to correspond to a progress direction of emitted light L as controlled by the beam steering unit 110. The waveguides 130 may be arranged on the same layer as the light amplifiers 140. In FIG. 2, the waveguides 130 and the light amplifiers 140 are depicted as being arranged on the substrate 120 as the same layer (“a common layer”), but the example embodiments are not limited thereto. That is, the waveguides 130 and the light amplifiers 140 may be arranged on the same layer, where the same layer is different from the substrate 120. In some example embodiments, where at least a portion of a waveguide 130 (e.g., second waveguide 132) is on a same layer as a light amplifier 140, a core layer (e.g., second core layer 232) of the portion of the waveguide may have an optical-axis (e.g., X2) that is partially or entirely aligned with an optical axis (e.g., X3) of an active layer 212 of the light amplifier 140.

Each of the light amplifiers 140 may include a semiconductor optical amplifier or an ion doping amplifier 217 (e.g., a light amplifier 140 that includes an active layer 212 at least partially defined by doping ions 217 in the light amplifier 140) (refer to FIG. 9).

The light amplifier 140 may include, for example, an active layer 212, a first clad layer 214, and an electrode 216. The active layer 212 may be configured to amplify light that is incident on the active layer 212. The active layer 212 and the first clad layer 214 may include a group III-V compound semiconductor material or a group II-VI compound semiconductor material. The active layer 212 may include, for example, GaAs, InGaAs, InGaNAs, InGaAsP, or InAlGaAs. The first clad layer 214 may include a semiconductor material having a band-gap greater (“larger”) than that of the active layer 212. The first clad layer 214 may include, for example, GaAs, GaP, AlGaAs, InGaP, GaAs, or InP. A material for the light amplifiers 140 may be selected in accordance with a wavelength (energy band-gap) of light L to be amplified. For example, when amplifying light L having a wavelength of 1.55 μm, the first clad layer 214, the active layer 212, or the first clad layer 214 and the active layer 212 may be InGaAs/InP. Restated, a light amplifier 140 configured to amplify light L having a wavelength of 1.55 μm may include a first clad layer 214 that includes InGaAs/InP, an active layer 212 that includes InGaAs/InP, or a first clad layer 214 and active layer 212 that each includes InGaAs/InP.

The electrode 216 may be arranged on the first clad layer 214. The electrode 216 may include a conductive material. In some example embodiments, the electrode 216 may include at least one metal selected from a group consisting of Ti, Au, Ag, Pt, Cu, Al, Ni, and Cr, an alloy of these metals, or a stack of these metals. However, the materials for the electrode 216 are not limited thereto, and may include at least one of indium-tin-oxide (ITO), indium-zinc-oxide (IZO), Ga—In—Zn-oxide (GIZO), Al—Zn-oxide (AZO), Ga—Zn-oxide (GZO), and ZnO.

As described herein, an element that is “on” another element may be above or beneath the other element. In addition, an element that is on another element may be directly on the other element (e.g., in direct contact with the other element) or may be indirectly on the other element (e.g., isolated from direct contact with the other element by at least one interposing element, space, or element and space).

The light amplifier (or semiconductor optical amplifier) 140 may amplify light L based on applying an electric field on both (“opposite”) sides of the light amplifiers 140 through the electrode 216. When an electric field is applied through the electrode 216, absorption of photons and stimulated emission of photons occur. When photons are absorbed, electron-hole pairs are generated, and when electron-hole pairs are combined, stimulated emission of photons occurs. If the stimulated emission of photons is greater than the absorption of photons, light may be amplified.

The waveguide 130 may include a first waveguide 131 arranged in front of the light amplifier 140 and a second waveguide 132 arranged on a rear of the light amplifier 140 with the light amplifier 140 as a center. Light L emitted from the beam steering unit 110 may propagate through the first waveguide and enter the light amplifier 140 through the first waveguide 131, such that the active layer 212 of the light amplifier 140 is configured to amplify light that is incident on the active layer 212 from the first waveguide 131 to generate amplified light, and light amplified by the light amplifier 140 (amplified light, also referred to herein as light “LA”) may propagate through the second waveguide 132 from the light amplifier 140.

The first waveguide 131 may include a first core layer 222 configured to direct light therethrough (through the first waveguide 131) and a second clad layer 224 that surrounds the first core layer 222. Accordingly, the first core layer 222 may be configured to direct light L, that is incident on the first core layer 222 from the beam steering unit 110, through the first waveguide 131. In some example embodiments, the second waveguide 132 may include a second core layer 232 configured to direct light therethrough (through the second waveguide 132) and a third clad layer 234 that surrounds the second core layer 232. Accordingly, the second core layer 232 may be configured to direct amplified light LA, that is incident on the second core layer 232 from the light amplifier 140, through the second waveguide 132.

Each clad layer of the second and third clad layers 224 and 234 may include a material having a different refractive index from the first and second core layers 222 and 232, respectively. For example, each clad layer of the second and third clad layers 224 and 234 may include a material having a refractive index less than that of the first and second core layers 222 and 232, respectively. The second and third clad layers 224 and 234 may include a silicon oxide material, a silicon nitride material, or a polymer light material. The second and third clad layers 224 and 234 are not requisite constituent elements. If the refractive index of the substrate 120 is less than that of the first and second core layers 222 and 232, the second and third clad layers 224 and 234 may be omitted. The substrate 120 and air that contact the first and second core layers 222 and 232 may function as the second and third clad layers 224 and 234.

The first and second core layers 222 and 232 may include a material having (“associated with”) a small nonlinear coefficient. The second core layer 232 may include a material having (“associated with”) a nonlinear coefficient that is less (“smaller”) than a nonlinear coefficient of the active layer 212 of the light amplifier 140 (e.g., a nonlinear coefficient with which the active layer 212 is associated). The second core layer 232 may include a material having (“associated with”) a nonlinear coefficient that is equal to or less than 50. The first core layer 222 may include the same material (a “common material”) as the second core layer 232. For example, the first and second core layers 222 and 232 may include a common material having a nonlinear coefficient that is equal to or less than 50. The first and second core layers 222 and 232 may include a silicon nitride material in which a composition ratio of nitrogen is greater than a composition ratio of silicon, for example, Si3N4. Thus, the first and second core layers 222 and 232 may include a silicon nitride material that is associated with a composition ratio of nitrogen and a composition ratio of silicon, where the composition ratio of nitrogen is greater than the composition ratio of silicon.

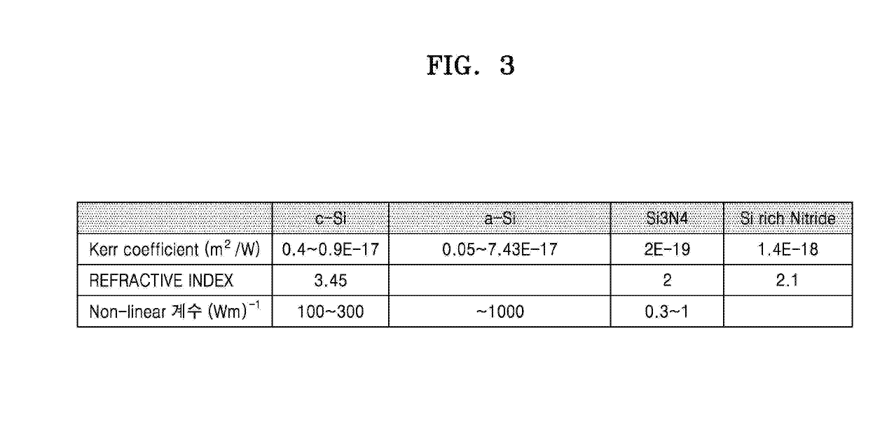

FIG. 3 shows a Table showing Kerr coefficients and nonlinear coefficients of materials according to some example embodiments. As depicted in FIG. 3, it is confirmed that Si3N4 and a Si-rich nitride have smaller Kerr coefficients than c-Si or a-Si. In some example embodiments, the nonlinear coefficient of the Si3N4 is much smaller than c-Si or a-Si. Thus, when the second core layer 232 includes Si3N4, even though high power light LA (for example, light of a few tens to 100 mW) emitted from the light amplifier 140 enters the second core layer 232, nonlinearity does not occur in the second core layer 232 of the second waveguide 132, and thus, high power light LA may progress through the second waveguide 132.

Each of the first and second core layers 222 and 232 may be arranged to directly contact the active layer 212, collectively or separately. For example, at least a region of the first core layer 222 may be arranged to overlap the active layer 212 with an optical-axis X1 of the first core layer 222 as a reference line, and in some example embodiments, at least a region (“portion”) of the second core layer 232 may be arranged to overlap the active layer 212 with an optical-axis X2 of the second core layer 232 as a reference line. A cross-sectional area of the first core layer 222 that contacts the active layer 212 may be greater than a cross-sectional area of the active layer 212 that contacts the first core layer 222 so that all light progressing through the first core layer 222 is applied to (“is incident to”) the active layer 212. Accordingly, the active layer 212 may be configured to amplify light that is incident on the active layer 212 from the first waveguide 131. In some example embodiments, a cross-sectional area of the second core layer 232 that contacts the active layer 212 may be greater than a cross-sectional area of the second core layer 232 that contacts the active layer 212 so that light amplified by the active layer 212 is applied to the second core layer 232, but the example embodiments are not limited thereto.

When the first waveguide 131 has the same structure as the second waveguide 132, the process for manufacturing the amplification waveguide device 200 may be simplified. However, generally, light L entering the first waveguide 131 from the beam steering unit 110 is not high power light. Therefore, the first core layer 222 may include a material having a low nonlinear coefficient.

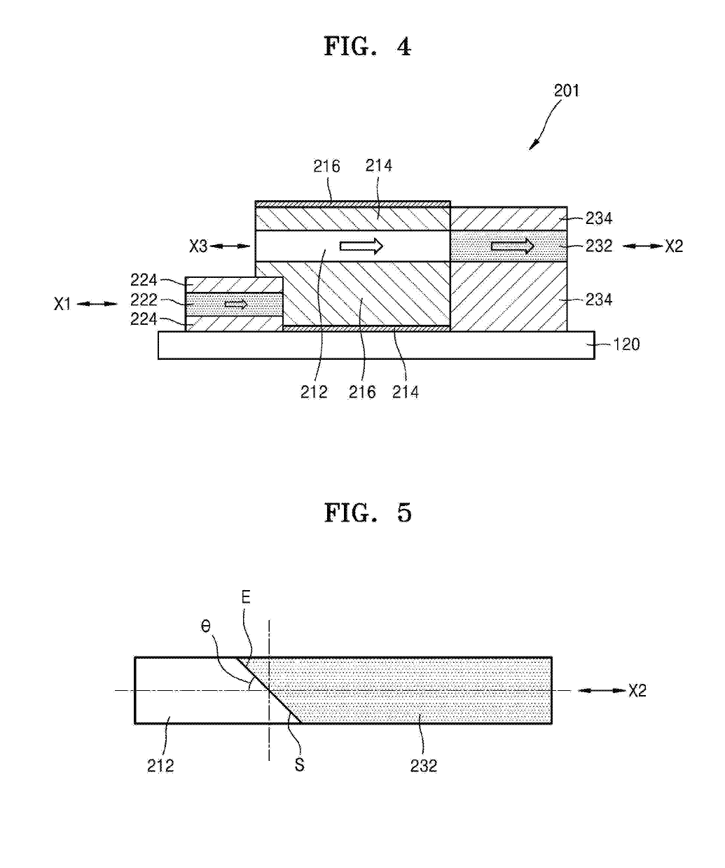

FIG. 4 is a cross-sectional view of an amplification waveguide device 201 according to some example embodiments. As depicted in FIG. 4, at least a region of the first waveguide 131 may be arranged on a lower region of the light amplifier 140. As further depicted in FIG. 4, the active layer 212 and the first core layer 222 may be arranged with (“associated with”) a step difference in height from the substrate 120, such that an optical-axis X1 of the first core layer 222 is offset from the optical-axis X3 of the active layer 212, as shown in at least FIG. 4. The first core layer 222 of the first waveguide 131 may not overlap the second core layer 232 with the optical-axis X2 of the second core layer 232 as a reference line. Light L emitted from the beam steering unit 110 may progress along the first waveguide 131 and may be activated in the light amplifier 140 by coupling with the light amplifier 140. Afterwards, light LA amplified by the light amplifier 140 may progress through the second waveguide 132.

High power light may not progress through the first core layer 222. Since the first core layer 222 should well apply light L emitted from the beam steering unit 110 to the active layer 212 of the light amplifier 140, the first core layer 222 may include a material that is readily optically coupled with the active layer 212. For example, the first core layer 222 may include a material having a similar refractive index to that of the active layer 212. The first core layer 222 may include, for example, silicon, a silicon oxide having a high composition ratio of silicon, or a silicon nitride having a high composition ratio of silicon.

In FIG. 4, it is depicted that the first core layer 222 is not directly in contact with the active layer 212, but the example embodiments are not limited thereto. At least a region of the first core layer 222 may directly contact the active layer 212. In some example embodiments, at least a region of the first core layer 222 may overlap the active layer 212 with the optical-axis X1 of the first core layer 222 as a reference line.

Referring to FIG. 1, it is depicted that an incident-end of the second core layer 232 is perpendicular to an optical-axis of the second core layer 232. However, the example embodiments are not limited thereto, that is, the incident-end of the second core layer 232 may be inclined by a particular (or, alternatively, predetermined) angle with respect to the optical-axis of the second core layer 232.

FIG. 5 is a diagram showing a connection relationship between the active layer 212 and the second core layer 232 according to some example embodiments. As depicted in FIG. 5, an incident-end S of the second core layer 232 may directly contact an emit-end E of the active layer 212. Even though the second core layer 232 may include a material having a low nonlinear coefficient, and since the second core layer 232 includes a material different from the active layer 212, a certain amount of light entering the second core layer 232 from the active layer 212 may be reflected by the incident-end S of the second core layer 232. Thus, in order to reduce the reflectivity at the incident-end S, the incident-end S of the second core layer 232 may be inclined with a particular (or, alternatively, predetermined) angle θ with respect to an optical-axis. For example, the incident-end S of the second core layer 232 may be inclined with an angle θ greater than 55 degrees with respect to the optical-axis X2 of the second core layer 232. In some example embodiments, the incident-end S of the second core layer 232 may be inclined with an angle θ greater than 55 degrees and less than 90 degrees with respect to the optical-axis X2 of the second core layer 232.

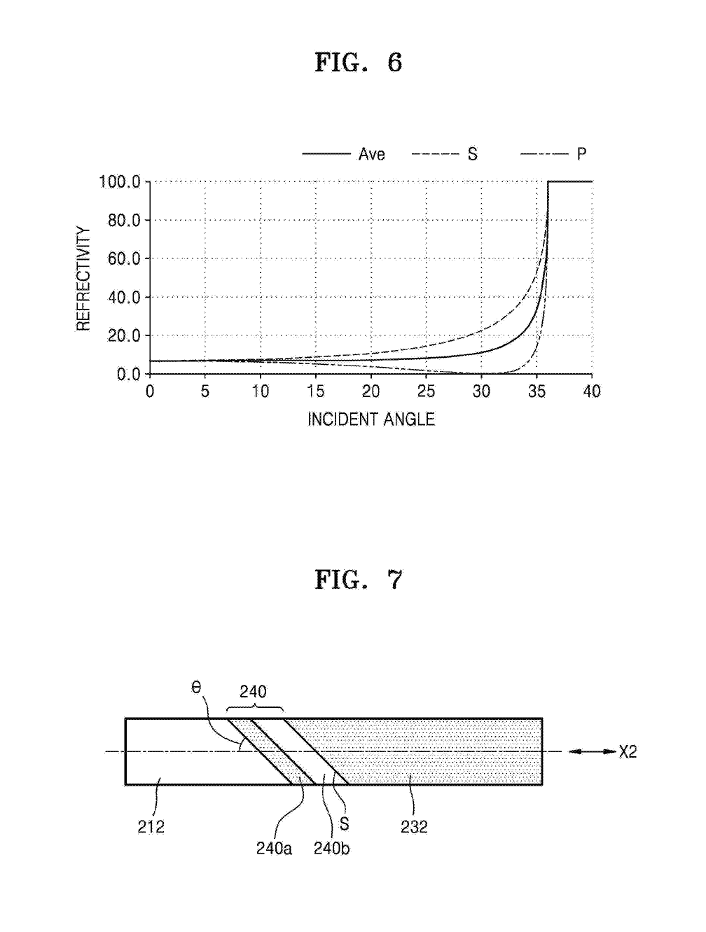

FIG. 6 is a graph showing reflectivity according to an angle θ of the incident-end S of the second core layer 232 with respect to the optical-axis X2 of the second core layer 232 according to some example embodiments. The active layer 212 includes a material having a refractive index of 3.4, and the second core layer 232 includes a material having a refractive index of approximately 2. The reflectivity in accordance with an incident angle θ was measured when a wavelength of progressing light is approximately 1300 nm. In FIG. 6, S indicates polarized light when the light is in a TE mode, and P indicates polarized light when the light is in a TM mode. As depicted in FIG. 6, when an incident angle θ is approximately greater than 35 degrees, it is confirmed that reflectivity has rapidly increased. Since an average of the incident angles θ is the optical-axis, in particular, when an angle θ between the incident-end S of the second core layer 232 and the optical-axis X2 of the second core layer 232 is greater than 55 degrees and less than 90 degrees, the reflectivity may be greatly reduced. Accordingly, reflection of light incident to the active layer 212 may be reduced by arranging the incident-end S of the second core layer 232 according to some example embodiments to be inclined by a particular (or, alternatively, predetermined) angle with respect to an optical-axis.

FIG. 7 is a diagram showing a connection relationship between the active layer 212 and the second core layer 232 according to some example embodiments. When FIG. 7 is compared with FIG. 5, a non-reflective coating layer 240 may further be arranged between the active layer 212 and the second core layer 232. The non-reflective coating layer 240 may have a structure in which a plurality of thin films, for example, two to three thin films having different refractive indexes from each other, are alternately stacked. For example, as shown in FIG. 7, the non-reflective coating layer 240 may include thin films 240a and 240b. In some example embodiments, the non-reflective coating layer 240 may have a refractive index between those of the active layer 212 and the first core layer 222. In some example embodiments, the non-reflective coating layer 240 may have a refractive index between those of the active layer 212 and the second core layer 232. Restated, the active layer 212 may have (“may be associated with”) a refractive index, the second core layer 232 may be associated with another refractive index, and the non-reflective coating layer 240 may have a refractive index that is between the refractive index of the active layer 212 and the refractive index of the second core layer. The non-reflective coating layer 240 may increase a gain bandwidth by reducing reflection and pressing a resonance phenomenon at the incident-end S of the second core layer 232. The non-reflective coating layer 240 may include SiO2, TiO2, ZnO2, or Si3N4, but is not limited thereto.

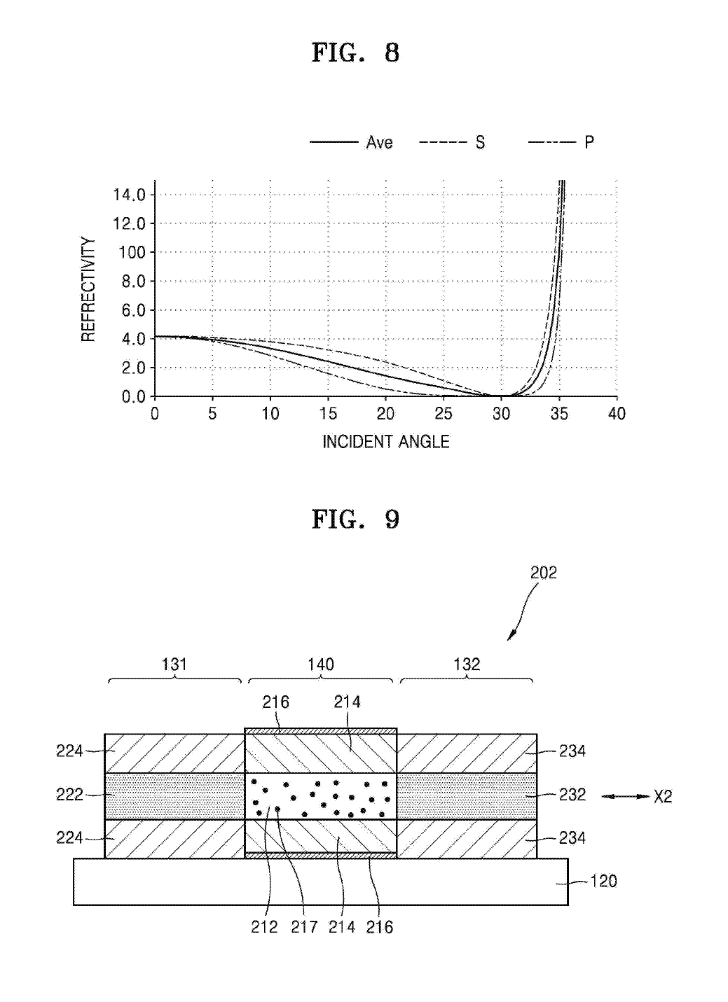

FIG. 8 is a graph showing measurement results of reflectivity when the non-reflective coating layer 240 is arranged according to some example embodiments. The active layer 212 includes a material having a refractive index of 3.4, and the second core layer 232 includes a material having a refractive index of approximately 2. A first thin film including SiO2 and a second thin film including TiO2 are arranged between the active layer 212 and the second core layer 232. As a result of measuring reflectivity, it is confirmed that the reflectivity is greatly reduced when compared to the result of FIG. 6. In particular, when the incident angle θ is 30 degrees, that is, the incident-end S of the second core layer 232 is inclined approximately 60 degrees with respect to the optical-axis X2 of the second core layer 232, it is confirmed that the reflectivity is almost zero regardless of the polarization characteristic of light.

FIG. 9 is a cross-sectional view of an amplification waveguide device 202 according to some example embodiments. As depicted in FIG. 9, in the amplification waveguide device 202, the light amplifier 140 may be formed by doping the waveguide 130 with ions 217 that may amplify light, such that the active layer 212 is doped with ions 217. The doping ions 217 may be, for example, erbium ions. If light L may be sufficiently amplified by using the doping ions 217, the light amplifier 140 may not be additionally provided to the waveguide 130 as a separate element, and thus, the amplification waveguide device 200 may be miniaturized at least by virtue of including a light amplifier 140 and waveguide 130 that are included in a unitary piece of material. For example, the clad layers 224, 214, 234 may be a unitary piece of material, and the layers 222, 212, 232 may be a unitary piece of material, wherein a portion of the unitary piece of material defining layers 222, 212, 232 may be doped with doping ions 217 to define the active layer 212 and thus to define layers 222, 232 as portions of the unitary piece of material that do not include the doping ions 217.

The beam steering apparatus 100 may further include a coupler 111 between the beam steering unit 110 and the waveguides 130, where the coupler 111 is configured to increase coupling effect light between the beam steering unit 110 and the waveguides 130. Restated, the coupler 111 may be configured to couple light L emitted from the beam steering unit 110 to the first waveguide 131 of at least one waveguide 130. The coupler 111 may be a collimating lens 150, an optical fiber 160, a grating, a sub-combination thereof, or a combination thereof.

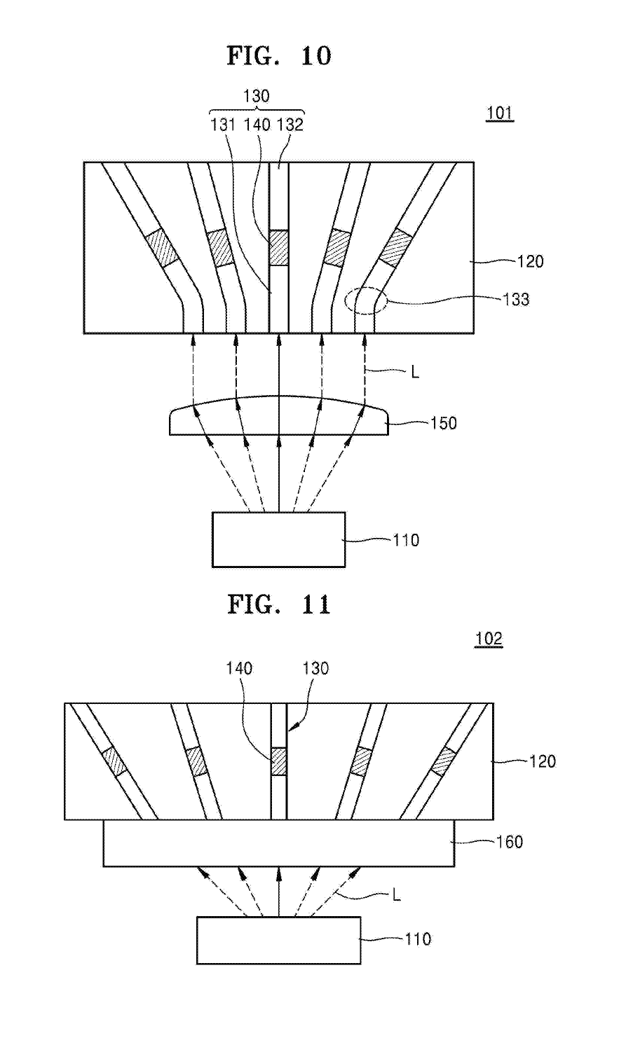

FIG. 10 is a schematic diagram of a beam steering apparatus 101 including the collimating lens 150 according to some example embodiments. Referring to FIG. 10, the collimating lens 150 makes incident light L beam parallel to each other to enter the waveguides 130. In this way, light coupling efficiency with respect to the waveguides 130 may be increased. In some example embodiments, collimated light L beams may enter the waveguides 130 through the collimating lens 150. At least one of the waveguides 130 may include a bending region 133 that changes a progress direction of light L. The bending region 133 has a curved surface, and thus, light L loss may be reduced.

FIG. 11 is a schematic diagram of a beam steering apparatus 102 including the optical fiber 160 according to some example embodiments. Referring to FIG. 11, the optical fiber 160 may be provided between the beam steering unit 110 and the waveguides 130. The optical fiber 160 may increase optical coupling efficiency by directly transmitting light L emitted from the beam steering unit 110 to the waveguides 130.

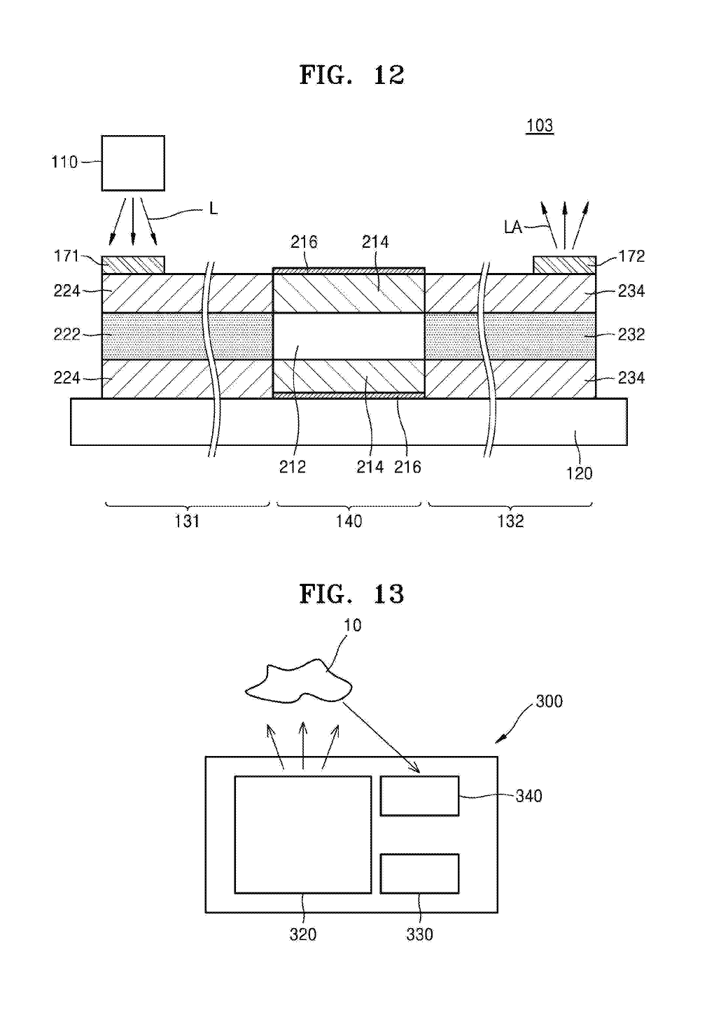

FIG. 12 is a schematic diagram of a beam steering apparatus 103 including a grating according to some example embodiments. Referring to FIG. 12, the beam steering unit 110 may be arranged above the waveguides 130. A first grating 171 may be arranged on a side of the waveguide 130, that is, the first waveguide 131 to which light L enters from the beam steering unit 110, and a second grating 172 may be arranged on a side of the waveguide 130, that is, the second waveguide 132 through which light LA is emitted.

The first grating 171 may perform as an input coupler, and the second grating 172 may perform as an output coupler. Light L emitted from the beam steering unit 110 enters the first waveguide 131 through the first grating 171 and is amplified by the light amplifier 140. Afterwards, the light LA progresses through the second waveguide 132 and may be outputted to the outside through the second grating 172. An input direction and an output direction of light LA may be controlled by the first and second gratings 171 and 172.

FIG. 13 is a schematic diagram of a system 300 including the beam steering apparatus according to some example embodiments. Referring to FIG. 13, the system 300 according to some example embodiments may include an beam steering apparatus 320 configured to amplify and steer a beam, a driving unit 330, and a detector 340 configured to detect a beam reflected by an object 10 after the steered beam is irradiated to the object 10. The driving unit 330 may include a driving circuit that drives the beam steering apparatus 320 and the detector 340. The beam steering apparatus 320 may be any of the beam steering apparatuses according to any example embodiments and may include any of the amplification waveguide devices according to any example embodiments.

The beam steering apparatus 320 may steer an incident beam to a desired location after amplifying the incident beam. The beam steering apparatus 320 may include the beam steering apparatuses 100 according to some example embodiments described above. In some example embodiments, when a beam steered by the beam steering apparatus 320 is irradiated and reflected, the detector 340 may detect the reflected beam. The system 300 to which the beam steering apparatus 320 is applied may be applied to various apparatuses, for example, a depth sensor, a three dimensional (3D) sensor, a light detection and ranging (LiDAR) system, etc.

The beam steering apparatus 100 according to some example embodiments may be applied to various apparatuses, for example, autonomous vehicles, flying objects, such as drones, mobile devices, bicycles, small walking means, such as baby carriages, skateboards, robots, internet of things, building security devices, or 3D imaging devices, etc. In some example embodiments, the beam steering apparatus according to some example embodiments may be applied to various household goods, such as walking sticks, helmets, clothes, accessories, watches, bags, etc.

In some example embodiments, based on providing increased compactness and/or omission of moving and/or mechanical elements, a beam steering apparatus may provide improved reliability, reduced cost, improved accuracy, a sub-combination thereof, or a combination thereof.

In some example embodiments, the system 300 may be included in one or more portions of a vehicle, including an automobile. A vehicle may include a vehicle that is configured to be driven (“navigated”) manually (e.g., based on manual interaction with one or more driving instruments of the vehicle by at least one occupant of the vehicle), a vehicle that is configured to be driven (“navigated”) autonomously (e.g., an autonomous vehicle configured to be driven based on at least partial computer system control of the vehicle with or without input from vehicle occupant(s)), some combination thereof, or the like. For example, in some example embodiments, the vehicle may be configured to be driven (“navigated”) through an environment based on generation of data by one or more systems 300 included in the vehicle. Such navigation may include the vehicle being configured to navigate through an environment, in relation to an object located in the environment, based on data generated by the system 300 (e.g., the detector 340) as a result of the system 300 (e.g., beam steering apparatus 320) emitting a light beam (e.g., a laser beam) into the environment and detecting the object in the environment, where the system 300 may detect the object based on detecting a reflection and/or scattering of the emitted light beam off of the object.

In some example embodiments, based on the system 300 providing improved reliability, improved accuracy, improved compactness, reduced cost, a sub-combination thereof, or a combination thereof, the system 300 may enable a vehicle to be configured to implement autonomous navigation of an environment, via incorporation of a system 300 that includes at least the beam steering apparatus as described herein, with improved reliability, reduced cost, reduced space requirements (“improved compactness”), a sub-combination thereof, or a combination thereof, within the vehicle to incorporate the system 300 that may enable environment monitoring to further enable autonomous navigation through the environment.

In some example embodiments, the system 300 omits moving mechanical elements, for example based on including the beam steering unit 110 including a tunable laser diode. Accordingly, the system 300 may have improved compactness, reliability, performance, a sub-combination thereof, or a combination thereof, in relation to systems associated with beam steering apparatuses that include one or more mechanical elements.

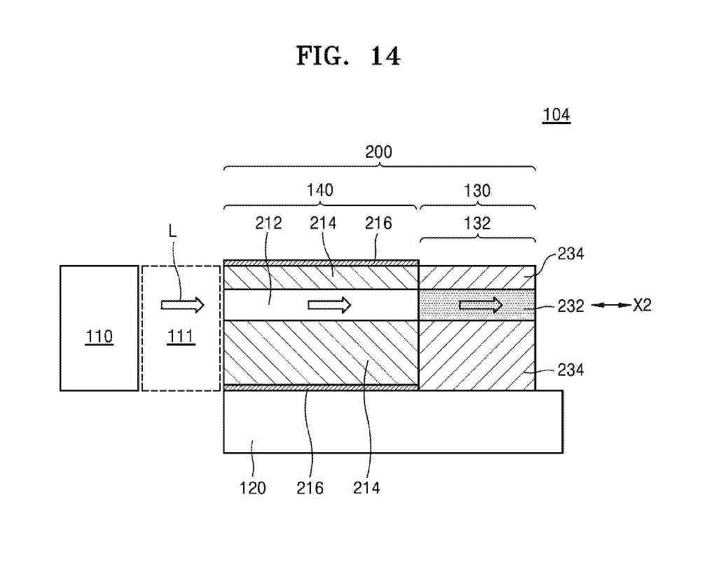

FIG. 14 is a schematic diagram of a beam steering apparatus 104 according to some example embodiments.

Referring to FIG. 14, the beam steering apparatus 104 may include an amplification waveguide device 200 that omits the first waveguide 131, such that the waveguide 130 comprises the second waveguide 132 and omits the first waveguide 131. Accordingly, the beam steering unit 110 may be arranged to direct light L directly to be incident on the active layer 212 of the light amplifier 140. The compactness of the beam steering apparatus 104 may thus be increased. In some example embodiments, the beam steering unit 110 directly contacts the active layer 212. In some example embodiments, the coupler 111 interposes between the beam steering unit 110 and the light amplifier 140 such that the coupler 111 couples L from the beam steering unit 110 to the active layer 212 of the light amplifier. The amplification waveguide device 200 may include a unitary piece of material, where the active layer 212 is defined as a portion of the light amplifier 140 that includes doping ions 217.

While one or more embodiments have been described with reference to the figures, it will be understood by those of ordinary skill in the art that various changes in form and details may be made therein without departing from the spirit and scope as defined by the following claims.

What is claimed is:

1. An amplification waveguide device, comprising:
a first waveguide comprising a first core layer, the first core layer configured to direct light through the first waveguide;
a light amplifier comprising an active layer, the active layer configured to amplify light that is incident on the active layer from the first waveguide to generate amplified light; and
a second waveguide on a same layer as the light amplifier, the second waveguide comprising a second core layer, the second core layer configured to direct amplified light that is incident on the second core layer from the light amplifier through the second waveguide.

2. The amplification waveguide device of claim 1, wherein the second core layer is associated with a nonlinear coefficient that is less than a nonlinear coefficient of the active layer.

3. The amplification waveguide device of claim 1, wherein the second core layer comprises a material associated with a nonlinear coefficient that is equal to or less than 50.

4. The amplification waveguide device of claim 3, wherein the second core layer comprises a silicon nitride material that is associated with a composition ratio of nitrogen and a composition ratio of silicon, and the composition ratio of nitrogen is greater than the composition ratio of silicon.

5. The amplification waveguide device of claim 1, wherein an incident end of the second core layer is inclined with an angle with respect to an optical-axis of the second core layer, the angle being greater than 55 degrees.

6. The amplification waveguide device of claim 1, wherein the active layer directly contacts the second core layer.

7. The amplification waveguide device of claim 6, wherein at least a portion of the second core layer overlaps the active layer with an optical-axis of the second core layer as a reference line.

8. The amplification waveguide device of claim 1, further comprising:
a non-reflective coating layer between the active layer and the second core layer.

9. The amplification waveguide device of claim 8, wherein the non-reflective coating layer—comprises a plurality of material layers having refractive indexes different from each other.

10. The amplification waveguide device of claim 8, wherein the non-reflective coating layer comprises a material having a refractive index between a refractive index of the active layer and a refractive index of the second core layer.

11. The amplification waveguide device of claim 1, wherein the first waveguide is on a same layer as the light amplifier.

12. The amplification waveguide device of claim 1, wherein the first core layer and the second core layer comprise a same material.

13. The amplification waveguide device of claim 1, wherein the first core layer directly contacts the active layer.

14. The amplification waveguide device of claim 1, wherein the first core layer has a step difference with the active layer, such that an optical-axis of the first core layer is offset from an optical-axis of the active layer.

15. The amplification waveguide device of claim 14, wherein the first core layer comprises silicon.

16. The amplification waveguide device of claim 1, wherein the active layer is doped with ions.

17. The amplification waveguide device of claim 16, wherein the ions comprise erbium ions.

18. A beam steering apparatus, comprising:
a beam steering assembly configured to change an emission direction of emitted light;
a first waveguide comprising a first core layer, the first core layer configured to direct emitted light that is incident on the first core layer from the beam steering assembly through the first waveguide;
a light amplifier comprising an active layer, the active layer configured to amplify light that is incident on the active layer from the first waveguide to generate amplified light; and
a second waveguide on a same layer as the light amplifier, the second waveguide comprising a second core layer, the second core layer configured to direct amplified light that is incident on the second core layer from the active layer through the second waveguide.

19. The beam steering apparatus of claim 18, further comprising:
a coupler configured to couple light emitted from the beam steering assembly to the first waveguide.

20. The beam steering apparatus of claim 19, wherein the coupler comprises a collimating lens, an optical fiber, a grating, a sub-combination thereof, or a combination thereof.

21. An amplification waveguide device, comprising:
a light amplifier comprising an active layer, the active layer configured to amplify light that is incident on the active layer to generate amplified light; and
a waveguide, the waveguide comprising a core layer, the core layer configured to direct amplified light that is incident on the core layer from the light amplifier through the waveguide.

22. The amplification waveguide device of claim 21, further comprising:
a first waveguide comprising a first core layer, the first core layer configured to direct light through the first waveguide,
wherein the active layer configured to amplify light that is incident on the active layer from the first waveguide to generate amplified light,
wherein the waveguide is a second waveguide and the core layer is a second core layer.

23. The amplification waveguide device of claim 21, wherein the active layer and the core layer are comprised in a unitary piece of material and the active layer is at least partially defined by doped ions.
